(19) United States
(12) Patent Application Publication
(10) Pub. No.: US 2009/0119072 A1
(43) Pub. Date: May 7, 2009

(54) Electromagnetic Modeling of Switch FETs

(76) Inventors: Steve E. Huettner, Tucson, AZ (US); Lawrence Wayne Tiffin, Vail, AZ (US)

Correspondence Address: SoCal IP Law Group LLP - Raytheon Company, 310 N. Westlake Blvd. Suite 120, Westlake Village, CA, 91362, US

(21) Appl. No.: 11/935,327

(22) Filed: Nov. 5, 2007

(51) Int. Cl. G06F 17/50

(52) U.S. Cl. 703/1

(57) ABSTRACT

There is disclosed a method for modeling a switch FET. A three-dimensional model representing the structure of the switch FET may be created. The three-dimensional model may be analyzed using an electromagnetic field analysis tool.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to modeling switch field effect transistors (FETs) at microwave and millimeter-wave frequencies.

2. Description of the Related Art

Switch FETs are used as control components in monolithic microwave integrated circuits (MMICs) and other circuits. Switch FETs are commonly used as two-state devices. In an ON state, the switch FET typically behaves like a resistor having a conductance that is proportional to the switch FET physical size. In an OFF state, the switch FET typically behaves like a small capacitor having a capacitance that is proportional to the switch FET physical size.

Switch FETs can be created with a variety of processes, including metal-semiconductor field effect transistors (MESFET), metamorphic high-electron-mobility transistor (MHEMT), and pseudomorphic high-electron-mobility transistor (PHEMT) processes.

Referring to FIG. 1A, a switch FET 100 is typically a three terminal device having a source electrode 110, a drain electrode 120, and a gate electrode (not shown). The source electrode 110 and drain electrode 120 are formed on a semiconductor substrate (not shown). The gate electrode is typically deposited between the source and drain electrodes. The gate electrode is used to control the switch FET, and a voltage applied to the gate electrode determines if the switch FET 100 is in the ON state or the OFF state. The gate electrode is commonly ignored when modeling the RF performance of a switch FET at microwave or millimeter-wave frequencies. The device shown in FIG. 1A is called a “meander-gate” switch FET. Other possible embodiments of switch FETs include source-over-drain and source-over gate air bridge structures.

A switch FET typically has a complex three-dimensional structure, such as the exemplary structure shown in the cross sectional view of FIG. 1B. The exemplary switch FET structure includes a semi-insulating substrate 140, which may be GaAs, a drain electrode 110, a source electrode 120, and a gate electrode 130. A channel 132 may be formed of N-doped semiconductor material, providing an electrical path from the drain electrode 110 to the source electrode 120. N+-doped contact layers 112 and 122 may be incorporated to provide low-loss connections from the source and drain electrodes, respectively, to the channel 132. A Schottky layer 135 may be formed over the channel 132. The gate electrode 130 may be formed over the Schottky layer 135. The conduction between the source electrode 110 and the drain electrode 120 may be controlled by controlling the electrical potential between the gate electrode 130 and the channel 132. With a zero or slightly positive voltage applied to the gate electrode 130, the channel may be fully conductive. With a negative voltage applied to the gate electrode 130, a depletion region may form in the channel adjacent to the gate electrode, and the conductivity of the channel may be reduced. With a sufficiently negative voltage applied to the gate electrode 130, a portion of the channel may be fully depleted and the source electrode may be effectively insulated form the drain electrode.

MMIC devices using microstrip transmission lines may include a ground plane 160 on the back surface of the substrate 140. MMIC devices using other transmission line techniques, such as coplanar waveguides, may not require a ground plane.

The performance of a switch FET, such as the exemplary switch FET 100, is commonly modeled at microwave or millimeter-wave frequencies using a two-terminal lumped-element model, such as model 170 in FIG. 1C. A switch FET model 170 may be modeled as a combination of transmission lines such as microstrip transmission line ML1 and ML2, and lumped elements such as capacitor C_{off} and resistor Rₒₙ. For MMIC circuits using other transmission line techniques, ML1 and ML2 would be replaced with appropriate transmission line models.

A lumped-element model such as model 170 may provide sufficient accuracy when modeling the performance of switch FETs at lower microwave frequencies such as X-band, but may not be sufficiently accurate for modeling circuit performance at millimeter wave frequencies such as Ka-band, Q-band, and W-band.

### DESCRIPTION OF THE DRAWINGS

FIG. 1A is a plan view of an exemplary switch FET.

FIG. 1B is a cross-sectional view of an exemplary switch FET.

FIG. 1C is a exemplary lumped element model of a switch FET.

FIG. 2 is a flow chart of a process for modeling switch FETs.

FIG. 3A is a schematic plan view of a simplified structure representing a switch FET.

FIG. 3B is a schematic cross-sectional view of a simplified structure representing a switch FET.

FIG. 4 is a graphical representation of data comparing modeled and measured performance of a switch FET.

FIG. 5 is a graphical representation of data comparing modeled and measured performance of a switch FET.

FIG. 6 is a block diagram of a computing device.

### DETAILED DESCRIPTION

Throughout this description, the embodiments and examples shown should be considered as exemplars, rather than limitations on the apparatus and methods disclosed or claimed.

Description of Processes

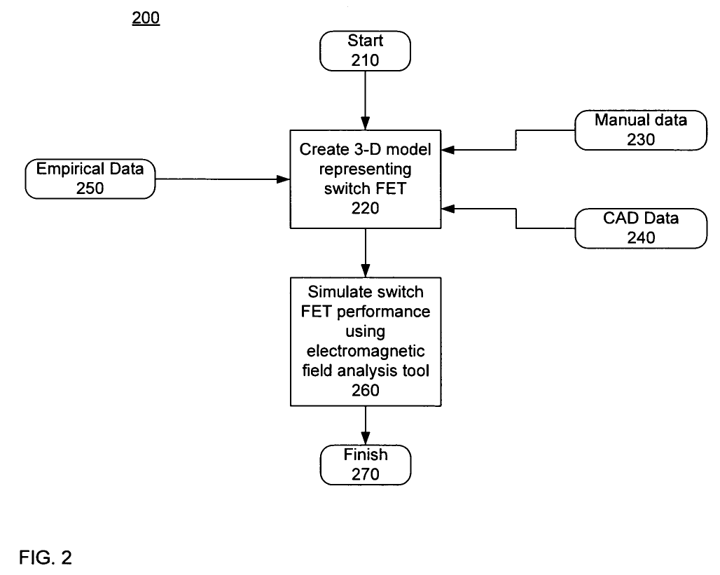

Referring now to FIG. 2, a flow chart of a process 200 for modeling a switch FET is shown. The process 200 may be suitable for modeling the exemplary switch FET 100 and for modeling other switch FET structures such as source-over-drain and source-over gate air bridge structures. The process 200 may be extended to model other components such as PIN diodes. The flow chart has both a start 210 and a finish 270, but the process may be repeated iteratively until the performance of the modeled switch FET meets some set of performance criteria.

At 220 a three-dimensional model representing the switch FET may be created. Within this description, a model is defined to be a data set containing data that captures the geometric and material properties of the switch FET. The data set constituting the model may be stored within a computing device, which may be running a computer-aided design (CAD) program, or may be stored within a storage device or on a storage media. The model may contain data defining edges, surfaces, vertices, volumes, and other geometric properties as appropriate to the CAD program being used. The model may contain data defining properties of materials constituting the various elements of the switch FET. The model may be created from a combination of data entered manually by a designer at 230, data imported from other CAD programs (such as an integrated circuit design and layout tool) at 240, and empirical data 250 including RF measurements of sample switch FETs that may represent a given manufacturing process from a given MMIC manufacturing facility. The empirical data 250 may be developed by comparing the results of modeling FET switch performance with the measured performance of actual FET switch devices at specific bias voltages.

Within this description, a three-dimensional model is said to “represent” the switch FET if the model captures the physical structure of the switch FET sufficiently to accurately simulate the performance of the switch FET at microwave frequencies. A three-dimensional model representing a switch FET may not be a faithful model of the switch FET geometry in three dimensions. Rather, a three-dimensional model representing a switch FET may only capture the geometric features of the switch FET that are significant to simulating the performance of the switch FET at microwave frequencies.

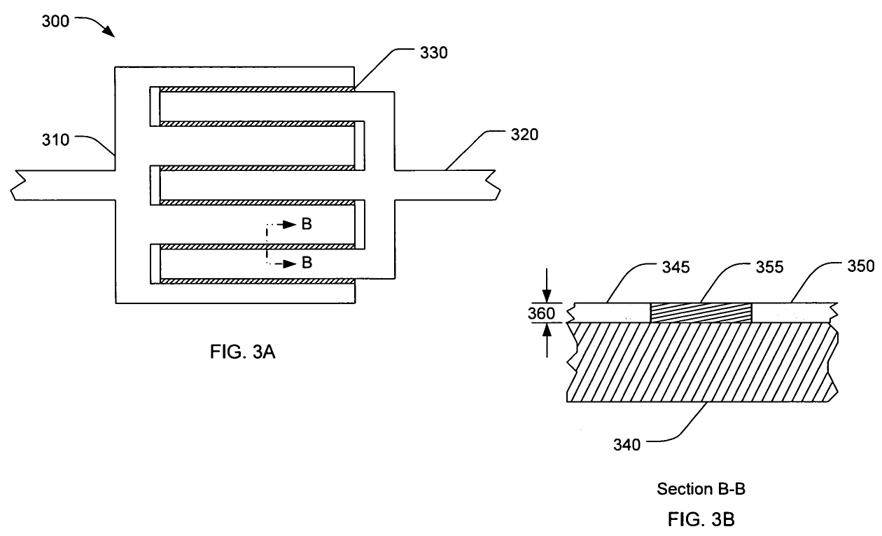

A three-dimensional model representing a switch FET may be a model of an imaginary simplified structure, such as the structure 300 shown in FIGS. 3A and 3B. The simplified structure 300 may include a model source electrode 310, a model drain electrode 320, and a model channel region 330. The word “model” is used herein as an adjective to distinguish the elements of the imaginary simplified structure 300 from the physical elements of the actual switch FET. The model source electrode 310, the model drain electrode 320, and the model channel region 330 may form a single layer of uniform thickness 360 on substrate 340, as shown in FIG. 3B. The thickness 360 may be defined equal to the physical thickness of the source and drain electrodes in the actual switch FET being modeled, or may be defined to be some other dimension.

A three-dimensional model representing a switch FET including source-over-drain or source-over-gate air bridge structures may include models of the air bridge structures. In this case, the model drain electrode 320, and the model channel region 330 may form a single layer of uniform thickness 360 on substrate 340, as shown in FIG. 3B, but at least the air bridge portions of the model source electrode may lie outside of the single layer (not shown).

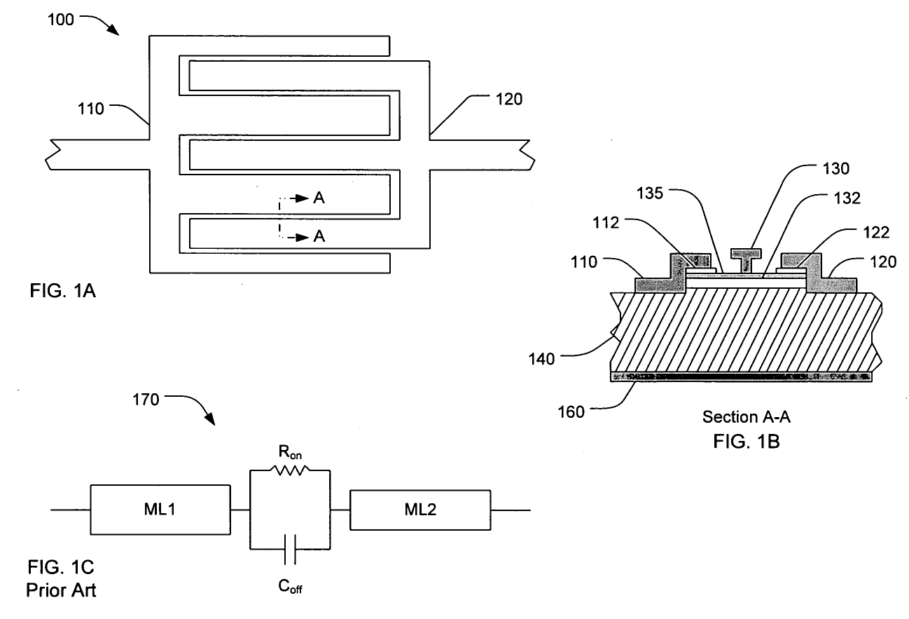

The simplified structure 300 may approximate the physical dimensions of the switch FET in the plane parallel to the substrate on which the switch FET is formed, as shown in FIG. 3A. The three-dimensional model of structure 300 may include data defining the model source electrode 310 and the model drain electrode 320, including air bridge structures where appropriate. The model source electrode 310 and the model drain electrode 320 may be defined to have the same dimensions as the actual source and drain electrodes of the switch FET being modeled (110, 120 in FIG. 1A, for example). The data defining the model source electrode 310 and the model drain electrode 320 may be entered into the model manually, or may be imported from a CAD tool.

The simplified structure 300 and the corresponding three dimensional model may not duplicate the structure of the switch FET on the axis normal to the substrate, such as the thicknesses of the channel, the contact layers, and the Schottky layer, and the geometry of the depletion region. Since these features may be extremely small compared to the wavelength at the microwave frequencies being modeled, the performance of a switch FET can be adequately modeled with a far simpler structure. The three dimensional model may include data defining the model channel region 330 as a bulk material filling at least part of the space between the model source electrode 310 and the model drain electrode 320.

The model channel region 330 may be defined to be a resistive material, having a conductivity σ, when a FET switch device is modeled in the ON state. The model channel region 330 may be defined to be a dielectric material, having a dielectric constant k, when a FET switch device is modeled in the OFF state. The value for the conductivity σ and the dielectric constant k may be selected empirically to achieve the best agreement between modeled and measured switch FET performance. Once the conductivity σ and the dielectric constant k are determined for specific bias voltage, a single switch FET geometry, and a specific switch FET manufacturing process, the empirical values for the conductivity σ and the dielectric constant k may be used to model a wide variety of switch FET devices made using the same manufacturing process and bias voltage.

Returning now to FIG. 2, the performance of the switch FET device may be simulated by analyzing the three-dimensional model representing the switch FET using a software tool adapted to solve 2.5D or 3D electromagnetic field problems. The software tool may be a commercially available electromagnetic field analysis tool such as the Momentum® tool provided by Agilent or the HFSS® tool provided by Ansoft. The electromagnetic field analysis tool may be a proprietary tool using any of the known mathematical techniques, such as finite difference time domain analysis, for solving electromagnetic field problems.

Some electromagnetic field analysis tools may allow the thickness (360 in FIG. 3B) of the source electrode, the drain electrode, and the channel region to be defined as zero. In this case, the conductivity of the channel material may be defined by a sheet resistance (ohms/square) when a FET is modeled in the ON state. Similarly, the dielectric characteristic of the channel material can be defined by a sheet capacitance which, although unconventional, allows scaling of the FET geometry. Both the sheet resistance and the sheet capacitance may be selected empirically to achieve the best agreement between modeled and measured switch FET performance.

Although the previous description has been limited to modeling a single switch FET device, the described methods can be applied to model more complex MMICs, such as digitally-controlled phase shifters incorporating multiple switch FETs interconnected by transmission lines and other elements. A single three-dimensional model may be developed to represent the entire MMIC and the performance of the entire device can be simulated using an electromagnetic field analysis tool.

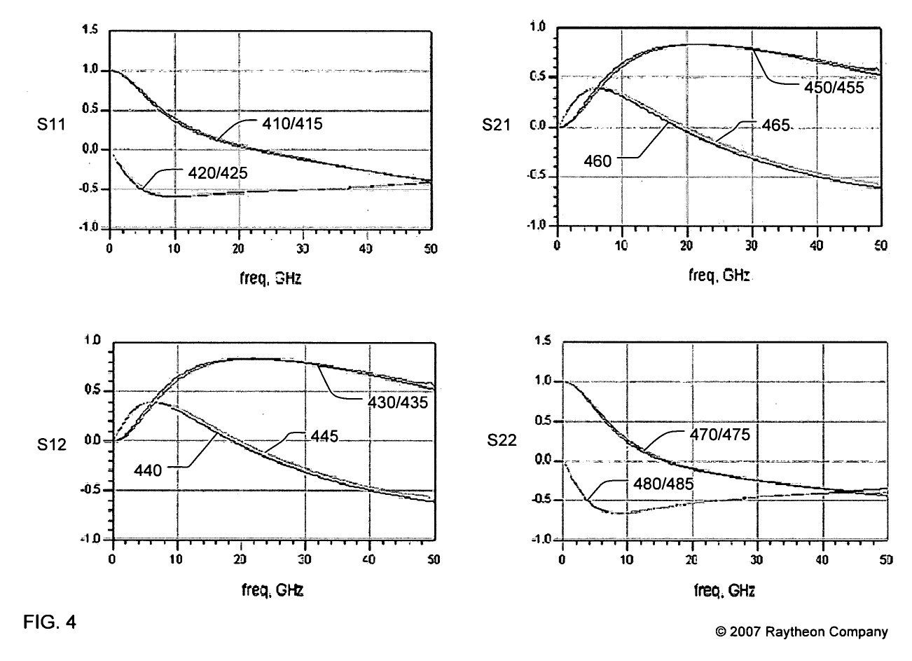

FIG. 4 shows a comparison between the measured and simulated performance of a representative switch FET in the OFF state. Within FIG. 4, four graphs show the scattering parameters, or S-parameters, for the real and simulated switch FET. S-parameters are a known and widely used method of characterizing components at microwave frequencies. Within the graph of parameter S11, lines 410 and 420 plot the real and imaginary components, respectively, of the S11 parameter as measured on a real switch FET device. Lines 415 and 425 plot the real and imaginary components, respectively, of the S11 parameter of the FET switch device as simulated by the previously described modeling process. Line 415 is barely distinguishable from line 410, and line 425 is barely distinguishable from line 420, indicating very good agreement between the simulated and measured results. The other graphs in FIG. 4 show similar plots for other S-parameters, using the reference designators defined in the following table:

component

| Parameter | Measured Data | Simulated Data |
|---|---|---|
| S12 real | 430 | 435 |
| S12 Imaginary | 440 | 445 |
| S21 Real | 450 | 455 |
| S21 Imaginary | 460 | 465 |
| S22 Real | 470 | 475 |
| S22 Imaginary | 480 | 485 |

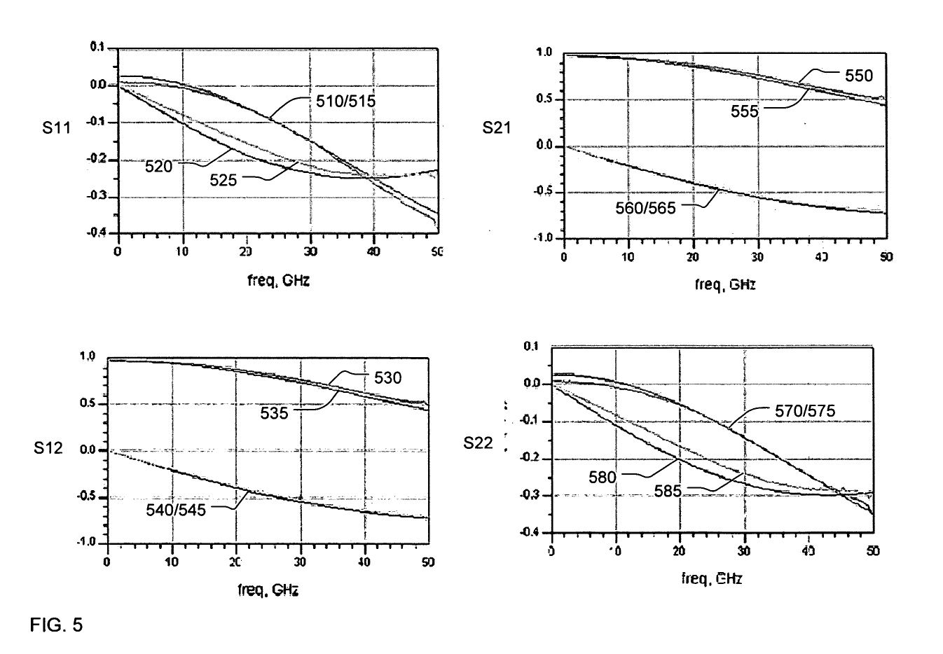

FIG. 5 shows a similar comparison between the measured and simulated performance of a representative switch FET in the ON state. Reference designators in FIG. 5 have the same meaning as the reference designators having the same two least-significant digits in FIG. 4.

Description of Apparatus

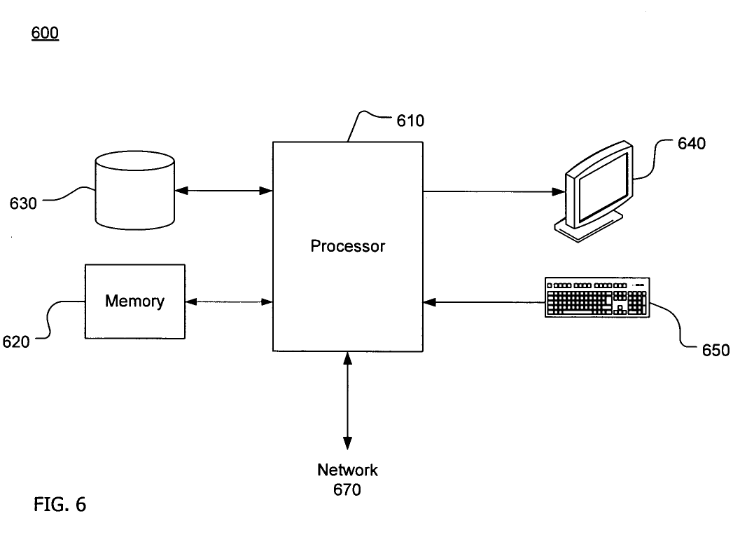

FIG. 6 shows a block diagram of an exemplary computing device 600. A computing device as used herein refers to any device with a processor 610 and a memory 620 that may execute instructions including, but not limited to, personal computers, server computers, main frame computers, computing tablets, work stations, portable computers, and laptop computers. The computing device 600 may also include, or be coupled with, at least one input device 650 and an output device 640. Computing device 600 may also include an interface to a network 670.

The computing device 600 may run an operating system, including, for example, variations of the Linux, Unix, MS-DOS, Microsoft Windows, Palm OS, Solaris, Symbian, and Apple Mac OS X operating systems. The computing device 600 may run one or more application programs. The application programs may be written in C++, Visual Basic, Smalltalk, or other programming language. The application programs may include algorithms and instructions for modeling FET switch devices as described herein.

The one or more application programs may be defined by instructions stored on a computer-readable storage media in a storage device 630 included with or otherwise coupled or attached to the computing device 600. These storage media include, for example, magnetic media such as hard disks, floppy disks and tape; optical media such as compact disks (CD-ROM and CD-RW) and digital versatile disks (DVD and DVD-RW); flash memory cards; and other storage media. As used herein, a storage device is a device that allows for reading and/or writing to a storage medium. Storage devices include hard disk drives, CD drives, DVD drives, flash memory devices, and others. The instructions stored on the computer-readable storage media may include instructions that cause the computing device to model switch FET devices as described herein.

Closing Comments

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A method for modeling a switch FET, comprising:
creating a three-dimensional model representing the structure of the switch FET analyzing the three-dimensional model using an electromagnetic field analysis tool.

2. The method for modeling a switch FET of claim 1, wherein the three-dimensional model represents the switch FET as
a model source electrode
a model drain electrode
a model channel region
wherein the model drain electrode, the model channel region, and at least a portion of the model source electrode are modeled as a single-layer structure formed on a substrate.

3. The method for modeling a monolithic microwave integrated circuit of claim 2, wherein the model includes three-dimensional air bridge portions of the source electrode.

4. The method for modeling a monolithic microwave integrated circuit of claim 2, wherein the model channel region is defined as a bulk material filling at least a portion of the single-layer structure between the model source electrode and the model drain electrode.

5. The method for modeling a monolithic microwave integrated circuit of claim 4, wherein the model drain electrode, the model channel region, and at least portion of the model source electrode are defined to have a thickness equal to a physical thickness of the source electrode and the drain electrode of the FET switch device being modeled.

6. The method for modeling a monolithic microwave integrated circuit of claim 4, wherein the model channel region is defined to be a dielectric material when the switch FET is modeled in an OFF state.

7. The method for modeling a monolithic microwave integrated circuit of claim 6, wherein a dielectric constant of the dielectric material is defined empirically by correlating performance data measured on actual FET devices with simulated performance data.

8. The method for modeling a monolithic microwave integrated circuit of claim 4, wherein the model channel region is defined to be a resistive material when the switch FET is modeled in an ON state.

9. The method for modeling a monolithic microwave integrated circuit of claim 8, wherein a conductivity of the resistive material is defined empirically by correlating performance data measured on actual FET devices with simulated performance data.

10. The method for modeling a monolithic microwave integrated circuit of claim 1, wherein the three-dimensional model is created, at least in part, from data imported from a CAD tool.

11. A storage medium having instructions stored thereon which, when executed by a processor, will cause the processor to perform actions comprising:
creating a three-dimensional model representing the structure of the switch FET
analyzing the three-dimensional model using a three-dimensional electromagnetic field analysis algorithm.

12. The storage medium of claim 11, wherein the three-dimensional model represents the switch FET as
a model source electrode
a model drain electrode
a model channel region
wherein the model drain electrode, the model channel region, and at least a portion of the model source electrode are modeled as a single-layer structure formed on a substrate.

13. The storage medium of claim 12, wherein the model includes three-dimensional air bridge portions of the source electrode.

14. The storage medium of claim 12, wherein the model channel region is defined as a bulk material filling at least a portion of the single-layer structure between the model source electrode and the model drain electrode.

15. The storage medium of claim 14, wherein the model drain electrode, the model source electrode, and the model channel region are defined to have a thickness equal to a physical thickness of the source electrode and the drain electrode of the FET switch device being modeled.

16. The storage medium of claim 14, wherein the model channel region is defined to be a dielectric material when the switch FET is modeled in an OFF state.

17. The storage medium of claim 16, wherein a dielectric constant of the dielectric material is defined empirically by correlating performance data measured on actual FET devices with simulated performance data.

18. The storage medium of claim 14, wherein the model channel region is defined to be a resistive material when the switch FET is modeled in an ON state.

19. The storage medium of claim 18, wherein a conductivity of the resistive material is defined empirically by correlating performance data measured on actual FET devices with simulated performance data.

20. The storage medium of claim 11, wherein the three-dimensional model is created, at least in part, from data imported from a CAD tool.
